(19) United States
(12) Patent Application Publication
(10) Pub. No.: US 2005/0082144 A1
(43) Pub. Date: Apr. 21, 2005

(54) High speed food product peeling or cleaning machine and method

(76) Inventors: Daniel D. Maupin, Corvallis, OR (US); David R. Zittel, Columbus, WI (US); Steven W. Hughes, Beaver Dam, WI (US)

Correspondence Address: David D. Stein;Boyle, Fredrickson, Newholm, Stein & Gratz, S.C., 250 E. Wisconsin Avenue, Suite 1030, Milwaukee, WI, 53202, US

(21) Appl. No.: 10/964,493

(22) Filed: Oct. 13, 2004

Related U.S. Application Data
(60) Provisional application No. 60/511,153, filed on Oct. 14, 2003.

(51) Int. Cl. A23N 7/00; A23N 7/02

(52) U.S. Cl. 198/659; 99/625; 99/628; 99/630

(57) ABSTRACT

An apparatus for peeling or cleaning food product that includes a plurality of rollers each coupled to a drive box, preferably a gear box, by a vibration dampening coupling that preferably is disposed exteriorly of one end of the roller and part of the frame of the machine that supports the roller. A drive that preferably is an electric motor is attached to the drive box such that a plurality of rollers is driven thereby. Such an arrangement enables rollers to be driven at speeds of 600 RPM and preferably 750 RPM or faster, which decreases processing time and increases capacity and throughput. In a method of operation, each roller is driven at a speed of 750 RPM or greater to peel or clean food product before being discharged from the machine. In one preferred method, the rollers are driven at speeds between 900 and 1200 RPM.

### CROSS REFERENCE TO RELATED APPLICATION

This application claims priority under 35 U.S.C. Section 119(e) to U.S. Provisional Application Ser. No. 60/511,153, filed Oct. 14, 2003, the entirety of which is hereby expressly incorporated herein by reference.

### FIELD OF THE INVENTION

The present invention is directed to processing food products, and more particularly, to an apparatus and corresponding method of peeling and cleaning food product at high speeds to achieve optimum throughput.

### BACKGROUND OF THE INVENTION

Machines and corresponding processes for processing food product have taken on many forms. Some such systems can be characterized as knife-type peelers that operate to peel and clean food product in a single step. However, knife-type peelers typically have a limited useful life and require significant maintenance in that the knives become blunt in a short amount of time and then need to be replaced.

In systems that utilize knives in a two-step process, a first step is used to remove impurities from food product by introducing the articles to a rough scraping surface of a peeling device. Thereafter, a second step is employed whereby the knives perform the peeling operation on the bulk product. Clearly, such systems are time consuming and not cost effective, with unacceptable throughput and processing quality.

In another type of system, rollers that include an elongated member for supporting a peeling element have been proposed. Such systems provide a one-step peeling process, but suffer in terms of speed and thus throughput. For example, such systems typically operate in the 300 to 400 revolution per minute range.

In one known machine, a roll configuration is used with knife blades used as their cutting elements. However, such systems grind large pieces of food product typically down to melon ball or golf ball sizes. In this system, raw product yield may be cut by 60% or more which typically is unacceptable for root crops that are canned or frozen. Examples of such root crops include French fries and potato chips.

In the past, it was believed that driving abrasive rollers of a bulk food product peeling or cleaning machine at rotational speeds in excess of 500 or 600 revolutions per minute could not be done for extended periods of time required in industrial applications because of issues relating to motor torque constraints, horsepower limitations, reliability, longevity, throughput, quality, and capacity. For example, while it is believed that the rollers of such peeling and cleaning machines could be driven using a belt drive at these higher speeds, it has not been believed that doing so for extended periods of time would be possible without its reliability suffering and failing prematurely. It also has been thought too difficult to do so by directly driving each roller with a motor because of horsepower and torque constraints. As a result, it has generally been thought impossible to drive the rollers of a machine capable of peeling or cleaning food product at speeds significantly higher than these for any kind of extended period of time and at the higher capacities and throughputs required for bulk or industrial food product processing applications.

It appears that there have been past attempts to try to drive rollers at such higher speeds, but they too have suffered from drawbacks and limitations. For example, there is a machine disclosed in PCT Publication No. WO 94/06311 for peeling or shaping potatoes and the like that is indicated as being capable of rotating one roller at a speed of 230 revolutions per minute and another roller at a speed of 2,800 revolutions per minute. Another machine for peeling potatoes and the like indicated as being capable of rotating grinding rolls at speeds of between 1,300 and 1,500 revolutions per minute is disclosed in European Patent Publication No. 0 322 252 A2. However, neither one of these machines is believed capable of being used in bulk or industrial food product processing applications where high capacity or throughput is required. In addition, the machine disclosed in WO 94/06311 is rather large and bulky, therefore not well suited for industrial food product processing applications. Moreover, potatoes are only peeled or shaped using two rollers at a time, severely limiting capacity and throughput. Finally, the drive arrangement disclosed in EP 0 322 252 A2 is unduly complex and prone to excessive maintenance or premature failure.

In addition, there are known peeling and shaping machines made by Oy Formit Foodprocessing AB of Storängsvägen 4, Närpes, Finland, such as that marketed under the tradename Formit Combi-Peeler. While roller rotational speeds of these machines are not known from their trade literature, these machines are of such limited capacity and throughput that they are unsuitable for bulk or industrial food processing applications where much greater capacity and throughput is demanded.

As a result, there is a need for a machine for food product peeling or cleaning food product that does so at higher roller speeds, greater capacities, and higher throughputs needed for industrial or bulk food product processing applications. What is also needed is a food product processing machine and corresponding method of peeling or cleaning food product with rollers rotating at a speed of at least 600 rpm with enough variability in auger speed, roll speed and roll selection to accommodate a variety of different products. What is further needed is a system that does so while maintaining longevity of the components by providing a design that is robust and accurate to aid ready maintenance.

### SUMMARY OF THE INVENTION

The present invention is directed to a food product processing machine for high speed peeling and cleaning applications that overcomes the drawbacks of prior systems. A food product processing machine constructed in accordance with the present invention employs rotatable rollers that are each rotatively supported at each end and coupled to a drive by a vibration dampening coupling that preferably is of flexible and elastomeric construction. Such a food product processing machine preferably also includes a drive box, preferably a gear box, connected to a plurality of the rollers and connected to a single drive. A mounting bracket is used to space the drive and drive box from one end of the machine such that each vibration dampening coupling of each roller is located between the end of the machine and the bracket.

In one preferred embodiment, each vibration dampening coupling is located outwardly or exteriorly of the bearings of the roller that it couples to the drive. Each roller preferably is rotatively supported at one end by a bearing that is attached to part of the machine adjacent one end of the machine and is rotatively supported at the other end by another bearing that is attached to part of the machine adjacent the other end of the machine.

In one preferred embodiment, the rollers are supported at each end by a roller support plate that has a plurality of notches with part of each roller received in one of the notches and rotatively supported by a bearing attached to the plate adjacent the notch. Preferably, each roller is rotatively supported at each end by a bearing that is attached to a corresponding one of the roller support plates.

Each roller support plate is carried by the frame. In one preferred embodiment, each roller support plate is immovably fixed to part of the frame of the machine located adjacent one end of the machine. If desired, each roller support plate can be part of a rotating cage, where the machine is configured as a rotating cage peeling or cleaning machine.

By rotatively supporting each roller adjacent both of its ends, roller vibration is reduced, thereby enabling each roller to be rotated at a higher rotational speed. By doing so, throughput and capacity are advantageously increased. In addition, each roller remains cleaner longer, reducing maintenance.

Each vibration dampening coupling is located outwardly of one of the roller support plates. This advantageously enables less vibration to be transmitted from the drive to each roller, which also enables each roller to be rotated faster. It also enables each roller to be more stably and securely supported adjacent each end downstream of the drive and coupling, further reducing vibration.

The drive box preferably is located between the drive and a plurality of rollers. The drive box preferably is a gear box that includes a plurality of transfer shafts each coupled to one of the rollers by a vibration dampening coupling.

A drive output is also connected to the drive box. In one preferred embodiment, a drive output shaft is connected to the drive box such that rotation of the drive output shaft causes each one of the transfer shafts of the drive box to rotate. Preferably, the drive output shaft is connected to an input shaft of the drive box. As a result, input from a single drive output shaft causes a plurality of rollers to rotate.

In a preferred embodiment, the input shaft and each transfer shaft include gears that communicate with at least one other gear to transfer power inputted via the input shaft to each one of the transfer shafts. In one preferred embodiment, the input shaft and each transfer shaft are connected to each other via a single gear, preferably an internal gear or ring gear. In another preferred embodiment, a belt, preferably a timing belt constructed of KEVLAR or the like, connects the input shaft to each one of the transfer shafts. Such a drive box preferably splits the power received from the drive output shaft to each one of the transfer shafts, and hence to each roller coupled to the transfer shaft.

The drive output shaft preferably is driven by a motor, preferably an electric motor. In a preferred embodiment, the drive output shaft is the output shaft of a single electric motor.

The drive box and motor are carried by a mounting bracket that spaces the arrangement sufficiently far away from adjacent roller ends to accommodate vibration dampening couplings being located between the drive box and rollers. This permits the vibration dampening couplings to be located exteriorly of the bearings and roller support plates that support each roller.

The frame of the machine preferably is of “frameless” construction, like that disclosed in U.S. Pat. No. 6,615,707, the disclosure of which is expressly incorporated herein. The frame is formed by a sidewall that is joined to a pair of end plates with one of the end plates being located at one end and the other one of the end plates located at the opposite end. Each end plate includes an integral side flange and an integral foot flange that stiffens, strengthens and structurally rigidifies the end plate. In a preferred embodiment, the sidewall is formed of a pair of sidewall panels that each extend from one end plate to the other end plate with the panels spaced apart so as to define a matter removal opening therebetween. A plurality of spaced apart braces extends between the end plates to further stiffen, strengthen, and structurally rigidify the frame. In one preferred embodiment, each brace preferably is tubular.

The machine includes a movable cover that overlies the rollers and the sidewall of the frame of the machine. The movable cover includes a plurality of drive cylinders that can be selectively actuated to lift the cover to provide access inside the machine. A hinge arrangement is employed to facilitate lifting of the cover.

In a preferred embodiment, there are a pair of drive cylinders both located adjacent one end of the machine with one of the drive cylinders located along or adjacent one longitudinally extending side edge or corner of the cover and the other one of the drive cylinders located along or adjacent the other longitudinally extending side edge or corner of the cover. The hinge arrangement is constructed and arranged to permit actuation of a single drive cylinder at a time to lift the longitudinally extending side edge of the cover adjacent the actuated drive cylinder upwardly and away from the frame of the machine. A sensor arrangement and control interlock are used to ensure proper drive cylinder actuation.

The machine can employ a food product conveyance apparatus to help urge food product being processed along the rollers. In one preferred embodiment, the food product conveyance apparatus is a helical auger that is driven by a drive that preferably is a motor, such as an electric motor. In a preferred embodiment, the auger and its drive are both carried by the cover.

In one preferred embodiment, the machine has a plurality of drive boxes each connected to a plurality of rollers by a vibration dampening coupling connected to each one of the rollers. A separate motor that preferably is an electric motor is connected to each drive box. Rotation of the drive output shaft of the electric motor causes each one of the plurality of rollers connected to the drive box to rotate.

In a method of operation, a plurality of pieces of food product is introduced into the machine, preferably through an inlet, such as an intake chute or the like. A plurality of rollers is each rotated at a rotational speed of at least 600 revolutions per minute and preferably 750 revolutions per minute or faster. In one preferred method of operation, a plurality of the rollers are rotated at rotational speeds of between 900 and 1,200 revolutions per minute and can be rotated at even higher speeds if desired.

Each piece of food product travels along the rotating rollers being processed thereby in a manner that, for example, peels them, cleans them, or peels and cleans them. Each piece of food product travels along the rotating rollers toward a discharge or outlet end of the machine. When food product processing is completed, each piece of food product is discharged from the machine.

As a result, a food product processing machine constructed in accordance with the invention is able to achieve high-volume product throughput, for example, of 100,000 pounds per hour. In one preferred method of operation, at least 60,000 pounds per hour of food product is processed by a machine constructed in accordance with the invention. In another preferred method of operation, at least 100,000 pounds per hour is processed.

Where the machine employs an auger, the auger is also rotated to help urge each piece of food product toward the discharge or outlet end of the machine. The rate of rotation of the auger and the rate of rotation of the rollers can be selectively controlled to control the residency time of each piece of food product.

Objects, features and advantages include one or more of the following: providing a food product processing machine that is capable of increased roller speeds that provide increased throughput, providing a food product processing machine where rollers are more stably rotated at higher rotational speeds with a minimum of vibration, that provides a food product processing machine that operates at high speeds and high rates of food product throughput while requiring less maintenance, providing a food product processing machine of simple, quick, and inexpensive manufacture that is durable, long-lasting, and easy-to-use, and providing a method of making and operating such a food product processing machine that is simple to implement, quick, labor-efficient, economical, and which requires relatively simple skills to operate.

Various features and advantages of the present invention will also be made apparent from the following detailed description and the drawings.

### BRIEF DESCRIPTION OF THE DRAWINGS

Preferred exemplary embodiments of the invention are illustrated in the accompanying drawings in which like reference numerals represent like parts throughout and in which:

FIG. 1 is a perspective view of a peeling or cleaning machine constructed in accordance with the invention;

FIG. 2 is an exploded view of the peeling or cleaning machine of FIG. 1;

FIG. 3 is an elevational end view of the machine depicting an inlet end thereof;

FIG. 4 is an elevational end view of the machine with its cover upraised relative to one side edge of the frame of the machine;

FIG. 5 is a transverse cross sectional view of the machine taken a distance away from its inlet end;

FIG. 6 is an enlarged fragmentary perspective view of part of the inlet end of the machine;

FIG. 7 is an exploded view of part of the frame of the machine depicting a roller support plate and its intended attachment to an end plate of the frame of the machine;

FIG. 8 depicts a rotatable roller being supported at each end by such a roller support plate;

FIG. 9 illustrates a bearing assembly attached to one of the roller support plates and rotatively supporting one end of the roller;

FIG. 10 is an exploded perspective view of a preferred bearing assembly embodiment;

FIG. 11 is a side cross sectional view depicting a preferred embodiment of a drive train and vibration dampening coupling arrangement that drives at least one rotatable roller;

FIG. 12 is an exploded perspective view of one preferred embodiment of a vibration dampening coupling;

FIGS. 13 and 14 depict perspective views of a drive box used to drive a plurality of rotatable rollers using a single drive input; and

FIG. 15 is a longitudinal cross sectional view of the machine showing it in use and operation in accordance with a preferred method of the invention.

Before explaining embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION OF AT LEAST ONE PREFERRED EMBODIMENT

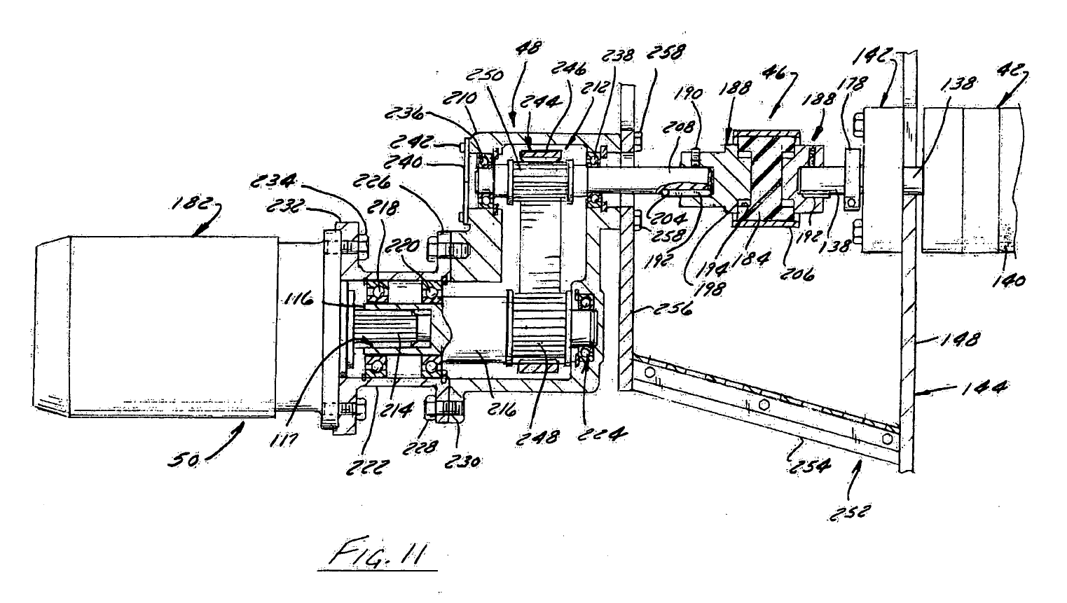

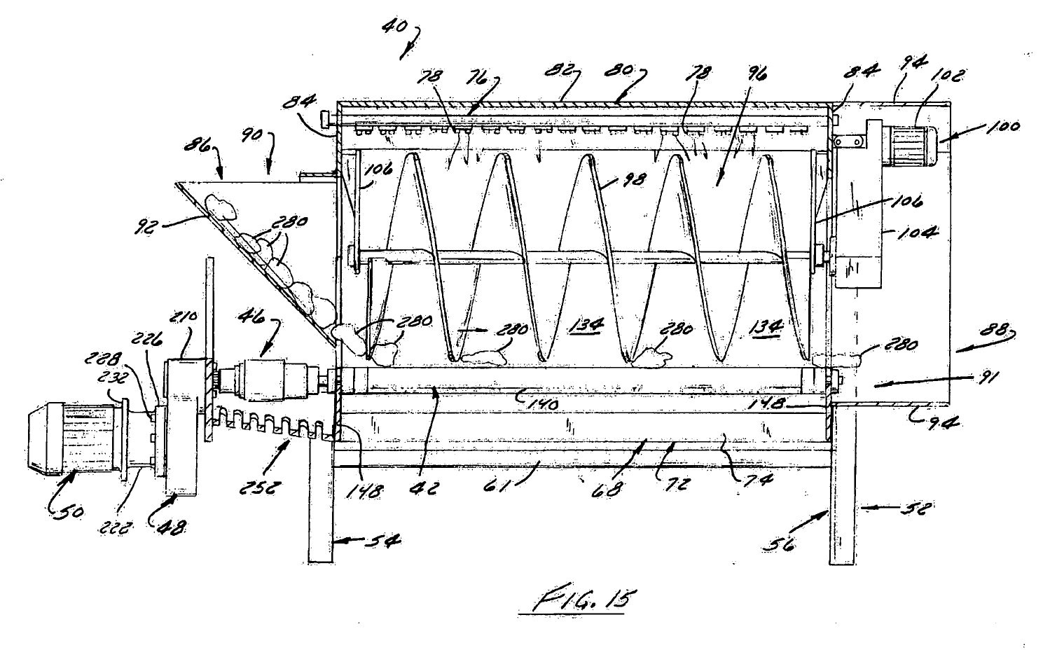

FIGS. 1 and 2 illustrate a preferred embodiment of a food product processing machine that preferably is a peeling or cleaning machine 40 that includes a plurality of food product processing rollers 42 driven by a drive arrangement 44 such that each roller 42 is rotatable at a rotational speed of greater than six hundred revolutions per minute and preferably seven hundred and fifty revolutions per minute or faster. The drive arrangement 44 preferably includes a vibration damping coupling arrangement 46 (FIGS. 11 and 14) for each roller 42 that helps enable each roller 42 to be rotated at such higher rotational speeds. In a preferred embodiment, the drive arrangement 44 includes a drive box 48 that preferably is a gear box used to transmit motive force to at least one of the rollers 42 from a drive 50.

The machine 40 includes a frame 52 that has a pair of end plates 54 and 56, each of which includes a pair of spaced apart legs 58 and 60 that support the machine 40 on a surface, such as the floor or ground. Each end plate 54 and 56 includes an outturned side flange 62 extending along each side edge that increases structural rigidity. Each leg 58 and 60 of each end plate 54 and 56 also preferably includes an outturned bottom flange 64 which serves as a foot. Each end plate 54 and 56 preferably is made of a single sheet of material of one-piece, unitary and homogenous construction. Each end plate 54 and 56 preferably is made of a food grade material, such as a stainless steel or the like.

There is a pair of braces 61 that each extends between the end plates 54 and 56. As is shown in FIG. 1, each brace 61 preferably is a tube that extends from the leg 58 of one end plate to the leg 60 of the other end plate. Each brace 61 helps reinforce, strengthen and structurally rigidify the frame 52.

The frame 52 includes a sidewall 66 that extends between the end plates 54 and 56. The sidewall 66 preferably has an arcuate cross section so as to help funnel material expelled by the rollers 42 during operation toward the bottom of the machine 40. The sidewall 66 includes a bottom opening 68 below the rollers 42 through which expelled material, such as dirt, debris, peels or the like, is removed.

The sidewall 66 preferably is made of a pair of curved or arcuately shaped sidewall panels 70 and 72, both of which extend between the end plates 54 and 56. As is shown more clearly in FIG. 5, each sidewall panel 70 and 72 has downwardly extending flange 74 that is spaced from the downwardly extending flange 74 of the other sidewall panel so as to define the material removal opening 68. The material removal opening 68 preferably extends substantially the length of the rollers 42 and preferably underlies the lowermost located rollers 42. Each sidewall panel 70 and 72 preferably is made of a single sheet of one-piece, unitary and homogenous construction. Each sidewall panel 70 and 72 preferably is made of a food grade material, such as a stainless steel or the like.

Liquid, such as water or the like, can be used to help facilitate material removal. As is shown in FIG. 2, the machine 40 preferably is equipped with a conduit 76 that discharges liquid during operation. The conduit 76 has orifices 78, preferably discharge nozzles or the like, from which the liquid is discharged. Orifices 78 preferably extend along the conduit 76 substantially the length of the rollers 42 to help ensure uniform distribution of discharged liquid. Referring additionally to FIGS. 3-5, a plurality of such conduits 76 can be employed. For example, as is shown in FIG. 5, three such conduits 76 are used.

Each conduit 76 is carried by a cover 80 of the machine 40 so as to overlie the rollers 42 and the sidewall panels 70 and 72 when the cover 80 is closed. The cover 80 includes an outer cover panel 82 that is of generally arcuate or curved cross section and which can be segmented, such as is in the manner depicted in FIGS. 1 and 2. The cover 80 also includes a pair of end walls 84, only one of which is clearly shown in FIGS. 1 and 2. The conduits 76 underlie the outer cover panel 82 and extend between the cover end walls 84. The conduits 76 are preferably carried by the cover end walls 84.

The machine 40 has an inlet end 86 and a discharge end 88. The inlet end 86 of the machine 40 includes a food product inlet 90 through which food product to be processed enter the machine 40. The food product inlet 90 preferably is a food product intake chute 92 that extends outwardly from the machine 40. The intake chute 92 can be carried by the frame 52 of the machine 40, such as is depicted in FIGS. 1 and 2, or can be carried by the cover 80. Where carried by the frame 52, the intake chute 92 preferably is carried by the inlet end plate 54 or the like.

The discharge end 88 of the machine 40 has a discharge outlet 91 from which processed food product are discharged. As is shown in FIGS. 1 and 2, the machine 40 can be equipped with an outwardly extending hood 94 or the like that extends outwardly from the discharge end 88.

As is shown in FIG. 2, the machine 40 preferably also includes a food product conveyance apparatus 96 that urges food product toward the discharge end 88 of the machine 40 during operation. The food product conveyance apparatus 96 preferably includes an auger 98 that is driven by an auger drive 100 that is a motor 102, preferably an electric motor. The motor 102 is connected by a drive box 104 that preferably is a gear box. During operation, the motor 102 rotates the auger 98 to urge food product being processed toward the discharge end 88 of the machine 40.

Where a food product processing machine 40 constructed in accordance with the invention employs such a conveyance apparatus 96, the apparatus 96 preferably is located between the rollers 42 and the cover 80 and overlies the rollers 42. In the preferred embodiment shown in FIG. 2, the food product conveyance apparatus 96 is mounted to the cover 80, preferably by a pair of brackets 106, each of which is located adjacent one of the cover end walls 84 and only one of which is shown in FIG. 2.

Referring additionally to FIGS. 3-5, the cover 80 cooperates with at least one of the sidewall panels 70 or 72 in a manner that permits it to be raised, such as for cleaning and maintenance, and lowered, such as when it is desired to operate the machine 40. In the preferred embodiment shown in FIGS. 1-5, the cover 80 is hingably attached along a side edge both of the sidewall panels 70 and 72 in a manner that permits the cover 80 to be selectively pivoted about one sidewall panel 70 and raised away from the other sidewall panel 72 and vice versa. This advantageously enables the location of the hingable attachment to be easily, conveniently and quickly switched or changed from one sidewall panel 70 to the other sidewall panel 72 so as to selectively permit access inside the machine 40 along or adjacent either sidewall panel 70 or 72 as the need dictates.

To enable the cover 80 to be raised in such a manner, there is a pair of drive cylinders 108 and 110 with one drive cylinder 108 located along one side of the cover 80 and the other drive cylinder 110 located along the other side of the cover 80. Each drive cylinder 108 and 110 has one end pivotally attached by a drive cylinder mounting bracket 112 to the frame 52 of the machine 40 and its other end pivotally attached by another drive cylinder mounting bracket 114 to the cover 80. In the preferred embodiment depicted in FIGS. 1-5, each drive cylinder 108 and 110 has a cylinder housing 116 that is attached to bracket 112, which extends from the end plate 56 adjacent the discharge end. Each drive cylinder 108 and 110 also has a reciprocable piston 118 that extends outwardly from the cylinder housing 116 and that is attached by bracket 114, which extends outwardly from the cover 80 a distance above its bottom edge and adjacent cover end wall 84.

Each side edge of the cover 80 is hingably attached to its corresponding sidewall panel by a hinge assembly 120, each of which preferably is of releasably latchable construction and only one of which is shown in FIGS. 3 and 4. For example, there is one such hinge assembly 120 used to hingably attach one side of the cover 80 to sidewall panel 72 and another such hinge assembly 120 (not shown in the drawing figures) of like construction used to hingably attach the other side of the cover 80 to sidewall panel 70. When it is desired to raise the cover 80 by moving one side of it away from a particular sidewall panel 70 or 72, the hinge assembly 120 adjacent that particular sidewall panel is unlatched or released and the drive cylinder adjacent that same particular sidewall is actuated.

In one preferred embodiment, such as is depicted in FIG. 6, each hinge assembly 120 includes at least one hinge pin 122 that can be removed or is movable to an unlatched position when it is desired to permit the cover 80 to be moved away from the sidewall panel 70 or 72 adjacent that hinge pin 122. In one preferred embodiment, the hinge pin 122 can be manually removed to unlatch the hinge assembly 120. Preferably, there is a plurality of such hinge assemblies 120 spaced apart along each side of the cover 80 where the cover and the corresponding sidewall panel 70 and 72 meet when the cover 80 is closed. For example, in the preferred embodiment shown in FIGS. 1-5, one hinge assembly 120 is located adjacent the inlet end 86 and another hinge assembly 120 is located adjacent the discharge end 88 along each side where the cover 80 and each sidewall panel 70 and 72 meet.

FIG. 3 illustrates the cover 80 in a closed position. FIG. 4 illustrates the cover 80 in a raised position such that one side edge of the cover 80 that previously overlaid the side edge of sidewall panel 70 in FIG. 3 is moved away from that sidewall panel 70. Before the cover 80 is raised, each hinge assembly 120 along that same side edge is unlatched, permitting the adjacent drive cylinder 108 to be actuated to raise the cover 80 in the manner depicted in FIG. 4. In raising the cover 80, the piston 118 of drive cylinder 108 is extended causing the cover 80 to pivot about the hinge assemblies 120 on the opposite side. To lower the cover 80, the piston 118 of the drive cylinder 108 is retracted until the cover 80 returns to the closed position shown in FIG. 3.

Each drive cylinder 108 and 110 preferably is a pneumatic cylinder that is controlled by a controller (not shown) that preferably relies upon an interlock or the like to ensure actuation of the desired drive cylinder only when the hinge assemblies 120 on the side adjacent the drive cylinder desired to be actuated are unlatched and the hinge assemblies 120 on the side opposite the drive cylinder to be actuated are latched. If desired, another type of drive cylinder, such as a hydraulic drive cylinder or an electric motor driven drive cylinder, can be used. One or more sensors 124, such as limit switches, proximity sensors, or the like, preferably are linked to the controller (not shown) and used to sense when the hinge assemblies 120 along a particular side are in a desirably latched or unlatched condition to enable the controller to appropriately permit or restrict drive cylinder actuation. Where each hinge assembly 120 includes a hinge pin 122, a sensor, such as sensor 124, is used to determine whether its associated hinge pin 122 has been removed so that the controller (not shown) can permit or restrict drive cylinder actuation. The controller (not shown) preferably includes controls that can be selected by a user to initiate raising or lowering of one side or the other side of the cover 80 in the aforementioned manner.

FIG. 6 illustrates a preferred embodiment of a hinge assembly 120 that includes a hinge pin 122. The preferred embodiment of the hinge pin 122 shown in FIG. 6 is a removable pivot pin 126 about which the cover 80 pivots when the opposite side of the cover 80 is raised. The pivot pin 126 pivotally attaches a strap 128 that extends downwardly from a cover end wall 84 to a bracket 130 that extends from the machine frame 52. Withdrawal of the pivot pin 126 preferably is prevented by a cotter pin 132 or the like that extends through the pivot pin 126. When it is desired to raise the side of the cover 80 adjacent the pivot pin 126, each pivot pin 126 along that side is removed. To do so, its cotter pin 132 is first removed, thereafter enabling removal of the pivot pin 126.

Referring once again to FIGS. 2 and 5, each roller 42 extends from adjacent the inlet end 86 to adjacent the discharge end 88. The rollers 42 preferably are parallel to one another and arranged to form a food product processing chamber 134 in which food product is processed during operation. The machine 40 preferably is equipped with between six and eleven rollers 42 and can have more, if desired. The rollers 42 collectively are arranged to form a food product processing chamber sidewall 136 that is of arcuate cross section. While the food product processing chamber sidewall 136 shown in FIGS. 2 and 5 is generally U-shaped, rollers 42 can be arranged to form a circular food product processing chamber sidewall (not shown), such as what is employed in a food product processing machine of rotating cage construction. For example, a food product processing machine constructed in accordance with the invention can also be configured as a rotating cage machine of the type disclosed in U.S. Pat. Nos. 5,780,088 and 5,989,614, the entirety of both of which are hereby expressly incorporated by reference herein.

Each roller 42 has a shaft 138 about which it rotates during operation. The shaft 138 carries a layer of material 140 whose outer surface engages food product in the food product processing chamber 134 during operation. The material 140 can be comprised of brushes, abrasive material, like sandpaper, disks, such as disks made of rubber, plastic or the like, radially outwardly projecting fingers, such as fingers made of plastic, rubber or the like, an elastomeric material, or another material that preferably is food grade suitable. Where brushes are employed, they can be, for example, made of nylon, plastic, or an elastomer.

Each roller 42 preferably is at least sixty inches in length and has an outer diameter of at least two inches. In a preferred embodiment, each roller 42 has a length of about eighty inches and an outer diameter of about five and one-quarter inches.

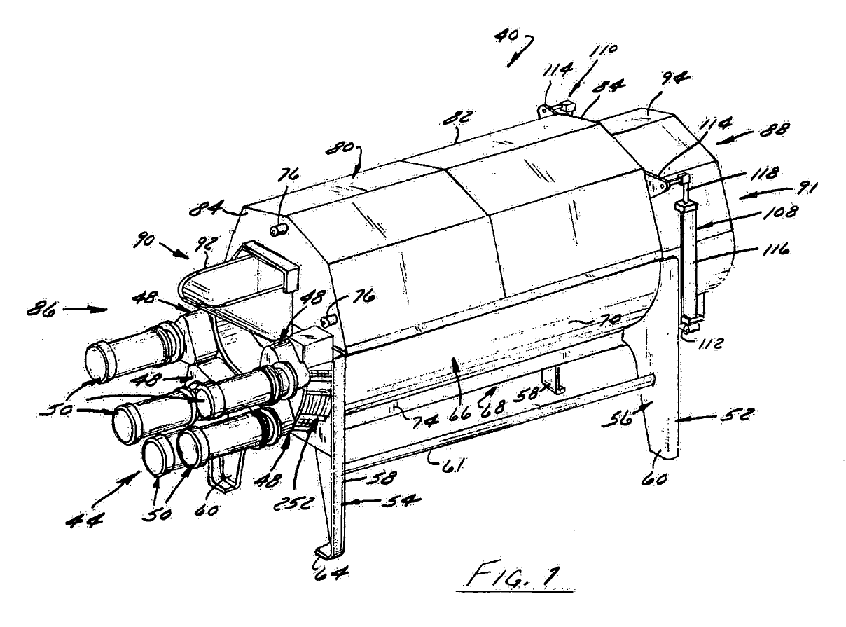

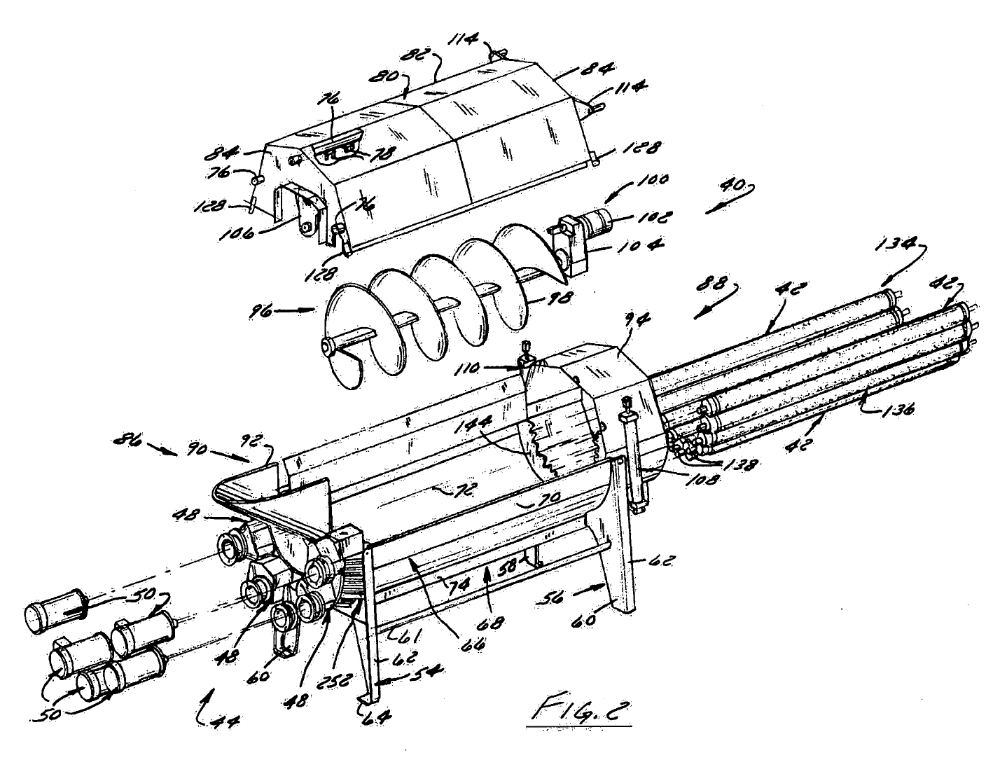

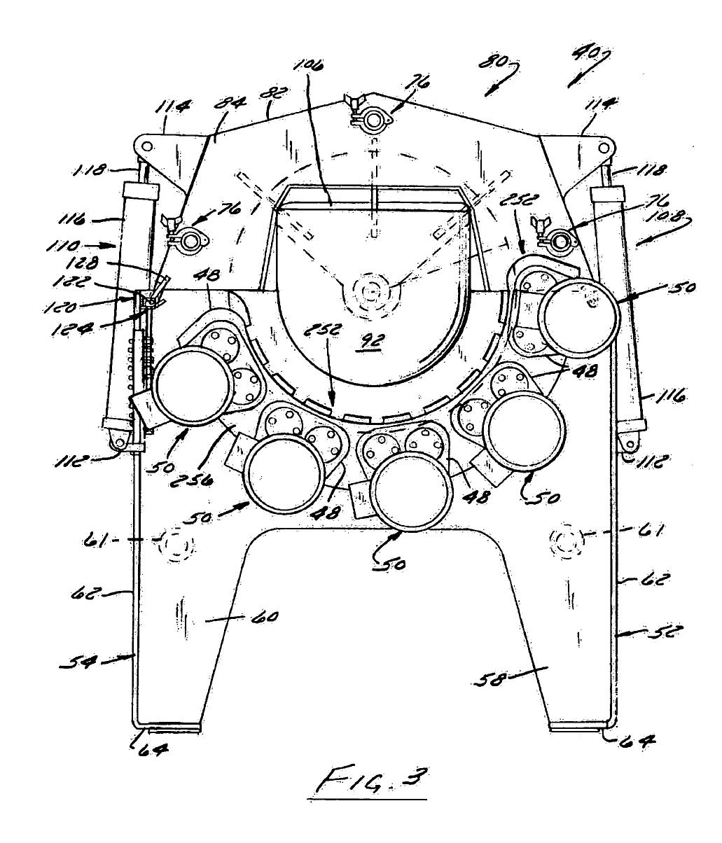

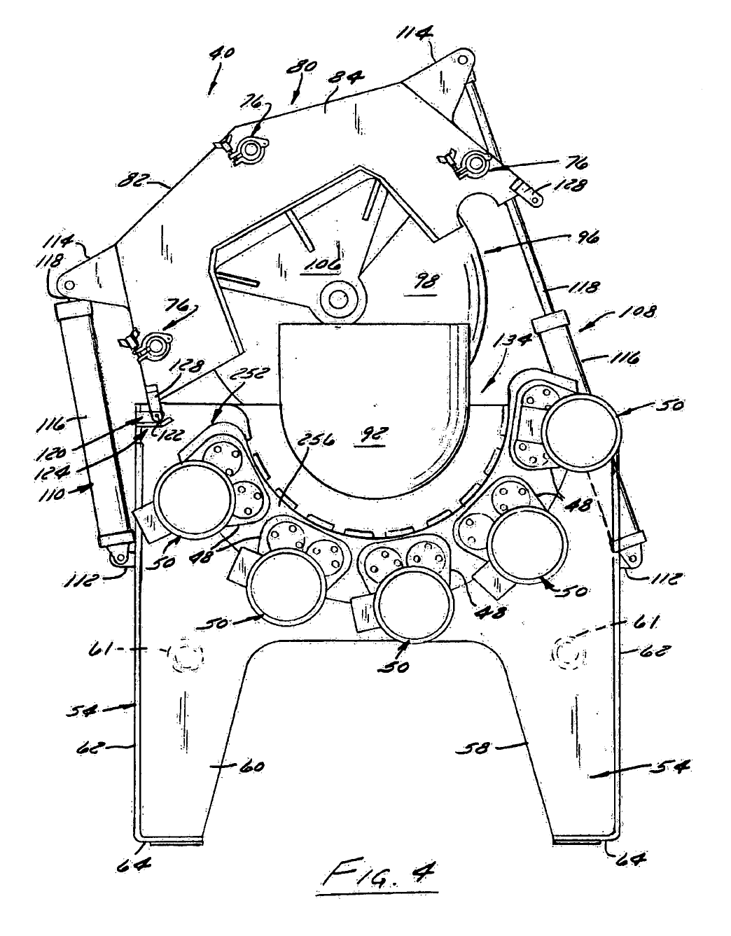

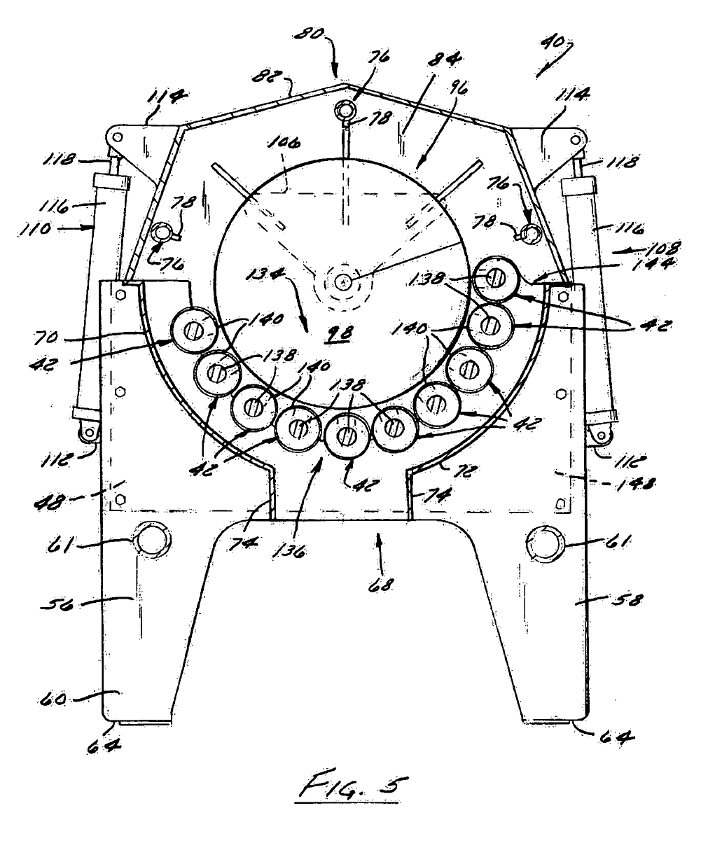

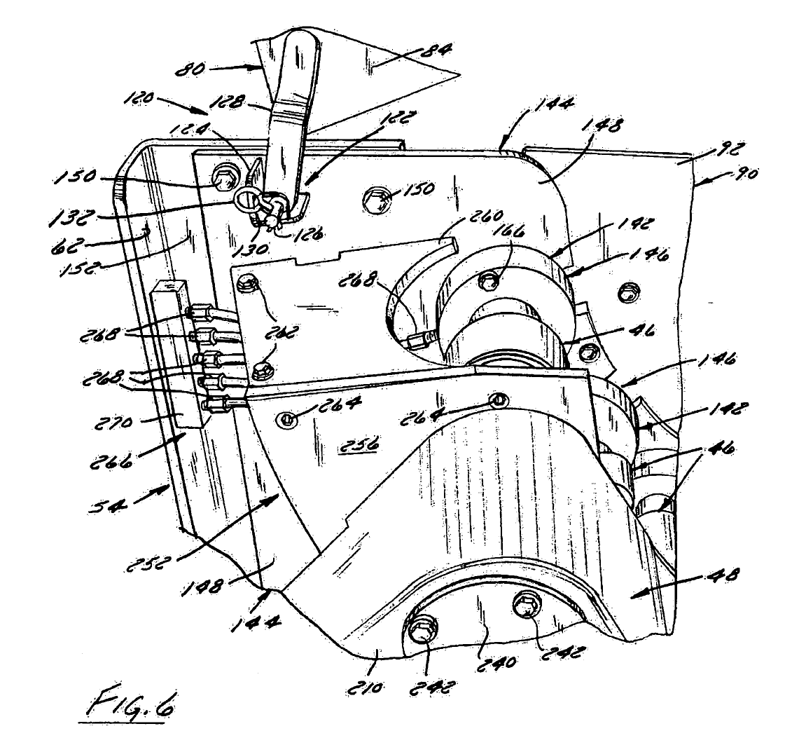

Referring additionally to FIGS. 6-10, each end of each roller shaft 138 is rotatively supported by a bearing assembly 142 that is attached to part of the frame 52 of the machine 40. The rollers 42 preferably are supported in a desired orientation and spaced apart relationship by a roller cradle 144 that has a plurality of spaced apart roller locator notches 146, each of which is constructed to accommodate part of a roller 42, preferably its shaft 138. In the preferred embodiment shown in FIGS. 6 and 7, the roller cradle 144 is a roller support plate 148 that is fixed to one of the end plates 54 or 56 of the frame 52 preferably using a plurality of fasteners 150, such as bolts or the like. As is depicted in FIGS. 6 and 7, the roller support plate 148 abuts against and overlies a generally planar center panel section 152 of the end plate 54 to which it is attached. Preferably, a roller cradle 144 of like construction is mounted to each end plate 54 and 56 with each notch 146 of one roller cradle 144 being aligned with a corresponding notch 146 of the other roller cradle 144 so as to orient the rollers 42 generally parallel to one another when the rollers 42 are assembled thereto.

As is shown in FIG. 7, each end plate 54 and 56 preferably has a roller clearance recess 154 formed in it to accommodate the rolls 42 when the roller cradle 144 is attached thereto. As is indicated by the fastener holes 156 in the roller cradle 144 and the fastener holes 158 in the corresponding end plate, such as end plate 56 shown in FIG. 7, the roller cradle 144 is attached by fasteners 150 (FIG. 6) to the end plate all along the periphery of the roller clearance recess 154 as well as along the outer periphery of the roller cradle 144. While the end plate and cradle are depicted in FIGS. 6 and 7 as being two separate components, the bearing cradle and end plate can be constructed from a single sheet of material such that the roller locator notches 146 are formed in each end plate 54 and 56.

In the preferred roller cradle embodiment shown in FIG. 7, each roller locator notch 146 of the roller cradle 144 is defined by a pair of spaced apart and outwardly extending roller bearing assembly mounting ears 160 and 162. As is shown in FIG. 7, each ear 160 and 162 of each notch 146 has a bore 164 through it for receiving a fastener 166 (FIG. 6), such as a bolt or the like, that is used to attach each one of the roller bearing assemblies 142 to the roller cradle 144. A plurality of fasteners 166 are used to attach each bearing assembly 142 to the roller cradle 144.

A roller cradle 144 of such construction advantageously makes roller assembly more precise thereby minimizing roller vibration during operation, enabling the rollers 42 to be rotated more smoothly and stably at higher rotational speeds. As a result, the life of each roller bearing assembly 142 is extended reducing maintenance and machine down time. Furthermore, a roller cradle 144 constructed in accordance with the present invention makes attaching and removing rollers 42 faster, easier and simpler to do. This not only makes initial assembly more economical, it also makes maintenance cheaper and faster to perform. As a result, machine down time for maintenance is advantageously reduced.

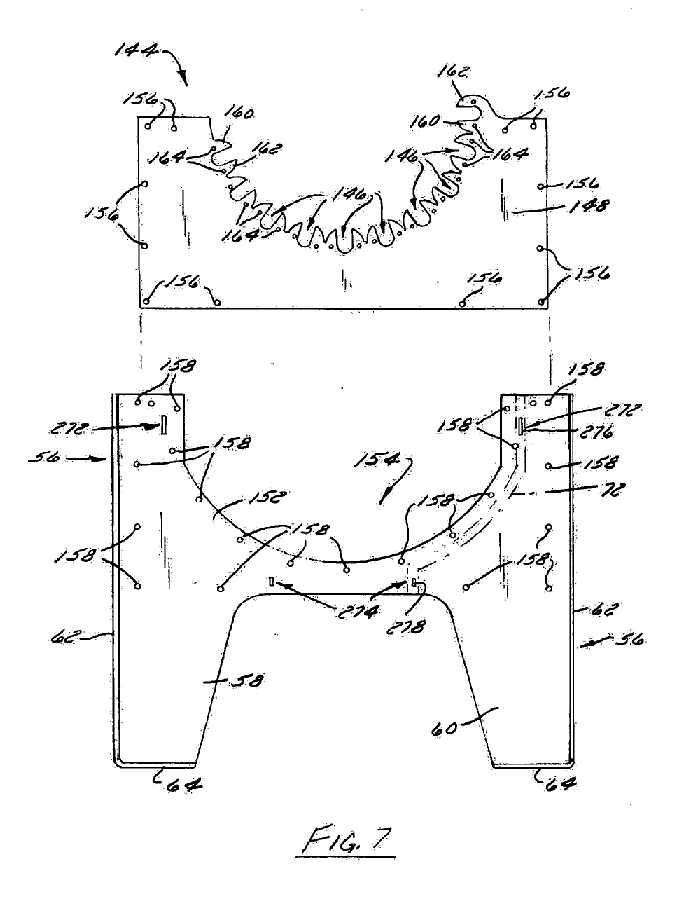

FIG. 8 illustrates a pair of the roller cradles 144 supporting one of the rollers 42 with one of the roller cradles 144 supporting the roller 42 adjacent one end of the roller 42 and the other one of the roller cradles 144 supporting the roller 42 adjacent the other end of the roller 42. Each end of the shaft 138 of the roller 42 extends outwardly through a locator notch 146 in its corresponding roller cradle 144 and beyond the cradle 144 to be received in a bearing assembly 142 attached to the cradle 144.

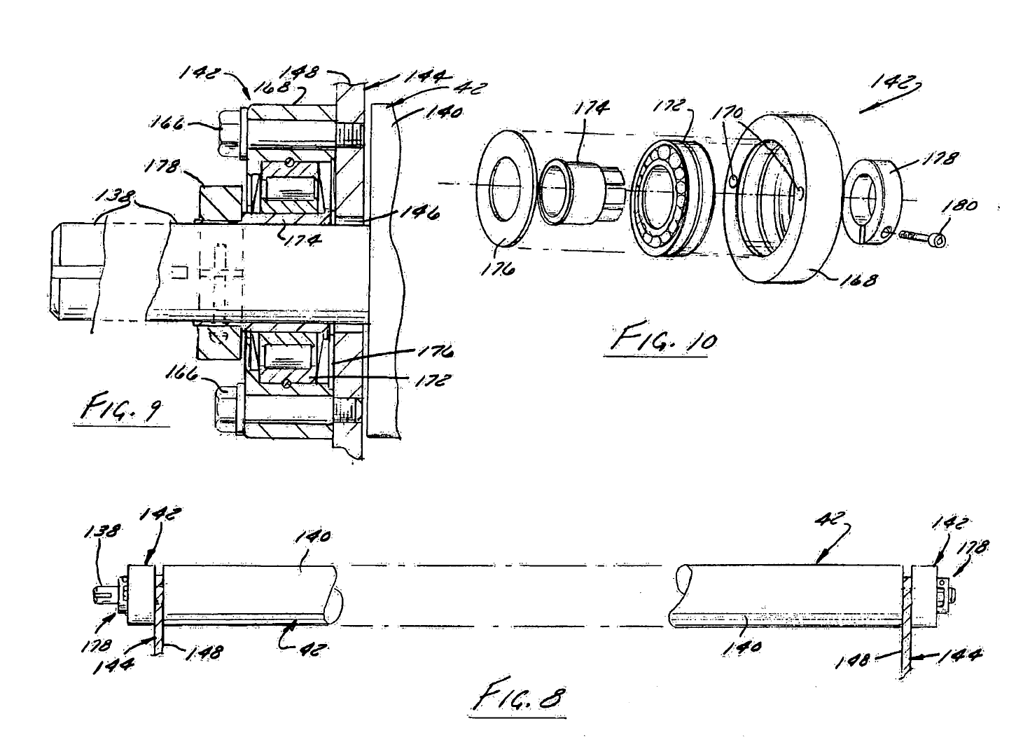

FIGS. 9 and 10 illustrate a preferred and exemplary embodiment of a bearing assembly 142. The bearing assembly 142 includes a ring-shaped bearing housing 168 that is attached to the cradle 144 using fasteners 166 that each extend through a bore 170 (FIG. 10) in the housing 168. An annular roller bearing 172 is disposed between the roller shaft 138 and the bearing housing 168. The bearing assembly 142 preferably also includes a bearing race clamp 174 that is disposed between the roller bearing 172 and the shaft 138. The bearing assembly 142 preferably includes a flat and annular bearing housing back plate 176 that is shaped like a washer and located between the roller bearing 172 and the cradle 144 to which the bearing assembly 142 is mounted. A set collar 178 is clamped around the roller shaft 138 outwardly of the bearing housing 168 and the roller bearing 172. A fastener 180 preferably is used to clamp the collar 178 around the roller shaft 138 adjacent the end of the shaft 138 such that axial shaft displacement is limited during operation.

Referring once again to FIG. 6, there is a bearing lubricant distribution arrangement 266 located at each end of the of the machine 40 that enables each bearing assembly 142 to be quickly, easily and efficiently lubricated. Each lubricant distribution arrangement 266 includes a lubricant conduit 268 that extends from a manifold 270 to each one of the bearing assemblies 142. Although not shown in the drawing figures, a lubricant pump (not shown) can be connected to each manifold 270 such as for enabling each bearing assembly 142 to be automatically lubricated. Otherwise, the manifold is equipped with grease gun fittings (not shown), enabling each bearing assembly 142 to be quickly and easily lubricated. In any event, the life of each bearing assembly 142 is advantageously extended, reducing machine down time as a result of reduced bearing assembly wear.

FIG. 11 illustrates a preferred embodiment of the drive arrangement 44 in more detail. The drive arrangement 44 includes a plurality of drives 50, each of which is a power input that preferably provides rotational motive force during operation to cause at least one of the rollers 42 to rotate. Each drive 50 preferably is a motor 182, preferably an electric motor or the like, that outputs at least about one horsepower during operation. In a preferred embodiment, the motor 182 is an electric motor that outputs about five horsepower. Where an electric motor 182 is used for each drive 50, a controller arrangement (not shown) like that disclosed in U.S. Pat. Nos. 5,780,088 and 5,989,614, the disclosures of both of which are hereby expressly incorporated by reference herein, preferably is employed. Such a controller arrangement preferably permits roller speed to be selectively varied by controlling its corresponding motor 182, such as by using a variable frequency drive or the like.

To help enable each roller 42 to be rotated at a rotational speed of six hundred revolutions per minute or more, there is a vibration dampening coupling arrangement 46 disposed between each roller 42 and it corresponding motor 182. As a result, each roller 42 preferably is rotatable at a speed of at least seven hundred and fifty revolutions per minute, and preferably between nine hundred and twelve hundred revolutions per minute. Each coupling arrangement 46 is of vibration dampening construction to help reduce roller vibration during operation to help enable its associated roller 42 to be rotated at such desirably high speeds. Each coupling arrangement 46 preferably is also constructed and arranged to accommodate shaft misalignment, preferably by being of flexible construction, which further helps reduce roller vibration during operation.

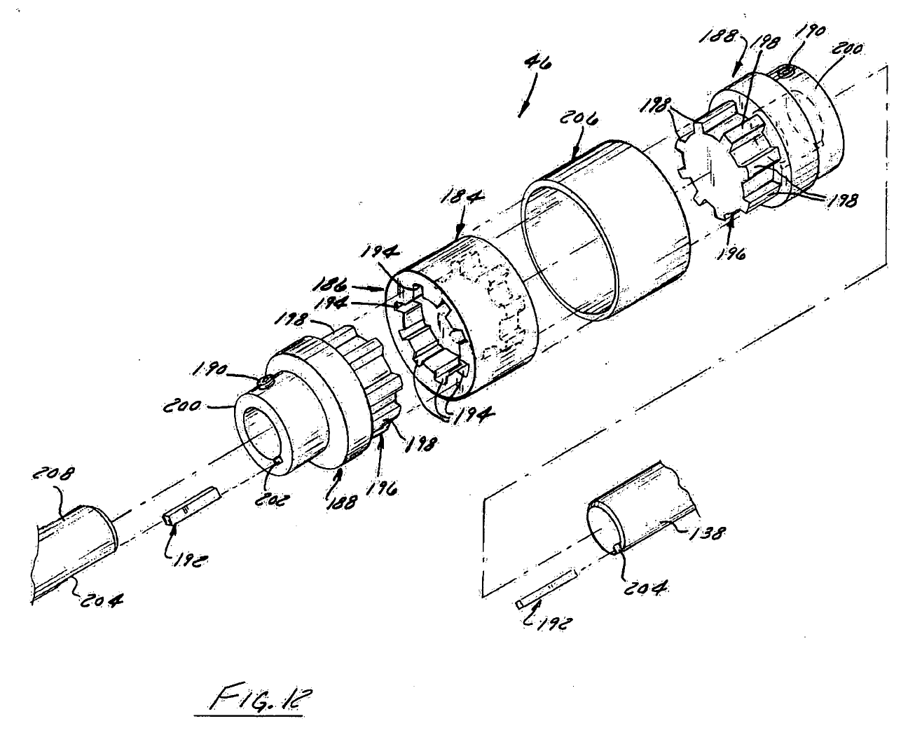

FIG. 12 illustrates a preferred embodiment of a vibration dampening coupling arrangement 46 in more detail. The flexible coupling arrangement 46 includes a generally cylindrical coupling sleeve 184 that preferably is of flexible and vibration dampening construction. The coupling arrangement 46 preferably is a flexible coupling of gear grip construction.

In the preferred embodiment depicted in FIG. 12, the coupling sleeve 184 is made of a resilient and tough material that preferably is non-metallic. One preferred coupling sleeve material is an elastomeric material, preferably neoprene, vinyl, nylon or the like.

Each end of the coupling sleeve 184 includes an inner female receptacle 186 that is three dimensionally contoured so as to mate with a hub 188 of complementary three dimensionally contoured male construction for rotation in unison therewith. Each hub 188 preferably attaches to one end of a shaft, preferably using a fastener 190, such as a set screw or the like. A key 192 preferably also is employed to key each hub 188 to its corresponding shaft for rotation in unison therewith.

The inner female receptacle 186 of the coupling sleeve 184 preferably extends substantially the length of the sleeve 184. If desired, each end of the sleeve 184 can have such a receptacle formed therein. The female receptacle 186 has a plurality of radial grooves or channels 194 formed therein that each extends in an axial direction, such as in the manner depicted in FIG. 12.

Each hub 188 has a head 196 that extends axially outwardly from one end that is of complementary construction to the sleeve receptacle 186. For example, in the preferred embodiment shown in FIG. 12, the head 196 of each hub 188 includes a plurality of radial ribs 198 that each extends in an axial direction.

The other end of each hub 188 includes a collar 200 that mounts to one end of a shaft. When the shaft is received in the collar 200, fastener 190 is tightened until one end bears against the shaft. Key 192 preferably is received in a keyway 202 formed in the collar 200 and in a keyway 204 in the shaft to help prevent relative rotation between the hub 188 and shaft.

When assembled, an outer protective cylindrical cover 206 preferably is provided that overlies the coupling sleeve 184, to help protect it during operation. Such a cover preferably is made of a food grade suitable material, such as, for example, a food grade suitable stainless steel or the like.

Each vibration dampening coupling arrangement 46 is used to couple the shaft 138 of one of the rollers 42 to an output shaft 208 through which power is supplied to the roller 42. While the output shaft 208 can be a drive shaft of a motor, it preferably is a power transfer shaft 208 that extends outwardly from one of the drive boxes 48.

Each drive box 48 includes a housing 210 that has inside a power transfer arrangement 212 that receives power inputted from a drive output shaft 214 and outputs it to at least one power transfer shaft 208 that, in turn, communicates it to a roller 42. Preferably, each drive box 48 has a plurality of power transfer shafts 208 such that the power input from a single drive 50 rotates each one of the plurality of power transfer shafts 208 and its corresponding roller 42.

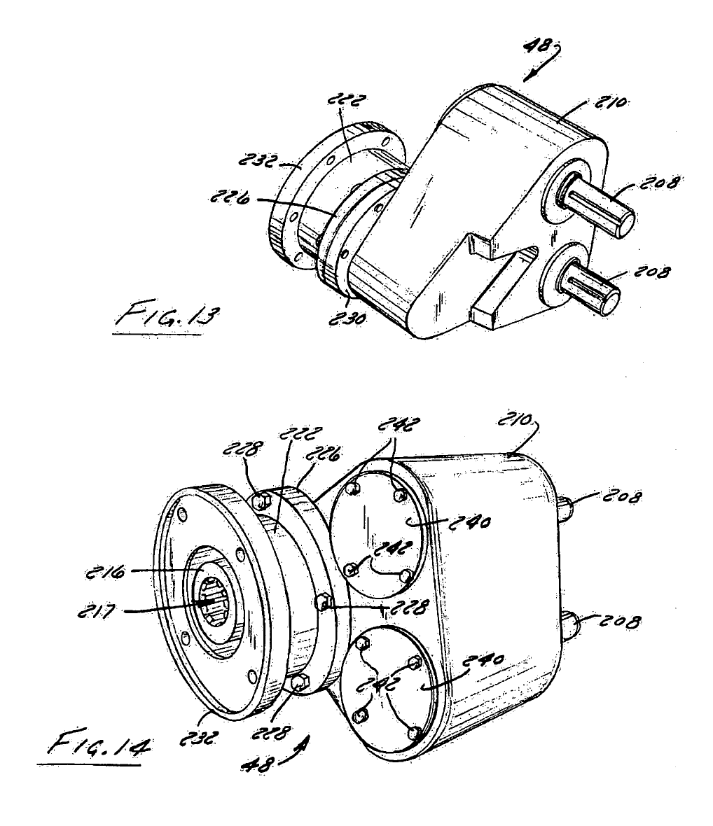

FIGS. 13 and 14 illustrate a preferred embodiment of the drive box 48. The drive box 48 has a pair of generally parallel and spaced apart power transfer shafts 208, each of which is coupled by a single coupling arrangement 46 to the shaft 138 of a single roller 42 in the manner depicted in FIG. 11. Each power transfer shaft 208 extends outwardly from the drive box housing 210, which encloses the power transfer arrangement 212 to prevent moisture, dust, dirt and debris from getting inside.

The drive box 48 includes a splined input shaft 216 that has a splined shaft receiver 217 that receives a complementarily splined drive output shaft 214. Engagement between the input shaft 216 and drive output shaft 214 enables the two shafts to rotate in unison. The input shaft 216 is rotatively supported by a plurality of bearings 218 and 220 adjacent one end in a flanged coupling 222 that attaches to the drive box housing 210. The input shaft 216 is further rotatively support by bearings 224 adjacent its other end, which is located in the drive box housing 210.

The flanged coupling 222 has a flange 226 at one end that is attached by fasteners 228 to a flange 230 of the drive box housing 210. The flanged coupling 222 includes another flange 232 at its other end that is attached by fasteners 234 to the drive 50, such as in the manner depicted in FIG. 11. The flanged coupling 222 can be removed from the drive box housing 210, such as when it is desired to service the power transfer arrangement 212, including the input shaft 216 and any one of its bearings 218, 220 and 224.

Each one of the power transfer shafts 208 is rotatively supported by a plurality of spaced apart bearings 236 and 238 with one of the bearings 236 located adjacent the end of each shaft 208 that is disposed in the drive box housing 210 and the other one of the bearings 238 located adjacent where each shaft 208 extends outwardly from the housing 210. There preferably is a removable cover 240 that overlies one end of each shaft 208 that is attached to the drive box housing 210 by fasteners 242. Each cover 240 can be removed from the drive box housing 210, such as when it is desired to service the power transfer arrangement 212, including its corresponding power transfer shaft 208 and any one of its bearings 236 and 238.

Referring in particular to FIG. 11, the power transfer arrangement 212 includes a connector 244 that connects the input shaft 216 to each one of the power transfer shafts 208. The connector 244 preferably is an endless band 246 that encircles the input shaft 216 and each one of the power transfer shafts 208. The input shaft 216 carries a splined or toothed pulley or gear 248 that engages the connector band 246 and each power transfer shaft 208 also carries a splined or toothed pulley or gear 250 that engages the connector band 246. As a result, the connector band 246 connects the input shaft 216 with each one of the power transfer shafts 208 such that they rotate substantially in unison when the drive 50 rotates the input shaft 216 during operation.

The power transfer arrangement 212 is constructed and arranged to distribute power from the drive 50 to each one of the rollers 42 coupled thereto. Preferably, power is distributed evenly such that each roller 42 coupled to a single drive box 48 rotates at substantially the same speed. If desired, the power transfer arrangement 212 can be constructed and arranged to provide a rotational output speed that is greater or less than that of the drive output shaft 214.

In one preferred embodiment, the connector band 246 is an internally toothed ring gear or internal gear that encircles and engages gear 248 of input shaft 216 and the gear 250 of each one of the power transfer shafts 208. Such a ring gear preferably is made of a solid material, preferably a metal, such as steel, stainless steel or the like. Gears 248 and 250 are externally toothed.

In another preferred embodiment, the connector band 246 is an endless flexible member, such as a belt, chain or the like. One preferred endless flexible member that can be employed as the connector band 246 is a timing belt. Where a timing belt is used, reference numerals 248 and 250 both refer to a timing belt pulley. Where a belt is used, it preferably is made of a strong, tough, durable and resilient material, such as KEVLAR, a composite, or another flexible material that can be composed of a fabric, a woven material, or the like.

Each drive box 48 is attached to the frame 52 of the machine 40 by a spacer bracket arrangement 252 that also acts as a guard that limits access to rotating components, such as the couplings 46, the power transfer shafts 208, and the roller shafts 138. The spacer bracket arrangement 252 includes a spacer 254 that extends outwardly from roller cradle 144 or end plate 54 and a mounting bracket 256 to which each drive box 48 is mounted. The spacer 254 can be of ribbed construction, such as is depicted in FIGS. 1, 2 and 15.

As is shown in FIG. 11, each drive box 48 is mounted to the mounting bracket 256 with a plurality of fasteners 258. The mounting plate 256 preferably extends at an obtuse angle relative to the spacer 254. The mounting plate 256 is fixed to the spacer 254, preferably by fasteners, welding or the like. The mounting bracket 256 is maintained substantially parallel to the roller cradle 144 and/or end plate 54, thereby helping to minimize any shaft misalignment between the power transfer shafts 208, the couplings 46 and roller shafts 138. As is shown in FIG. 6, there is a gusset plate 260 along each edge of the mounting plate 256 that helps further secure and structurally rigidify the spacer bracket arrangement 252. Other gussets can be employed between the gusset plates 260 to further secure and structurally rigidify the spacer bracket arrangement 252.

In the preferred embodiment shown in FIG. 6, the spacer 254 is fixed to the roller cradle 144. The spacer 254 can be welded or attached by fasteners (not shown). The gusset plate 260 preferably is attached to the spacer 254 and mounting bracket 256 by a plurality of fasteners 262 and 264. Each gusset plate 260 preferably helps keep the mounting bracket 256 substantially parallel to the roller cradle 144.

FIG. 7 illustrates a preferred embodiment of an end plate, namely end plate 56, that has a plurality of pairs of spaced apart locator slots 272 and 274 that receives corresponding outwardly extending tabs 276 and 278 of each one of the sidewall panels 70 and 72 to help locate and fixture the sidewall panel for assembly to both end plates 54 and 56. Sidewall panel 72 is shown in phantom in FIG. 7 assembled to end plate 56. Tab 276 of the sidewall panel 72 is received in locator slot 272 and tab 278 of the sidewall panel 72 is received in locator slot 274.

During assembly, both sidewall panels 70 and 72 are maneuvered to insert the tab 276 of each respective sidewall panel into slot 272 and tab 278 into slot 274 of each end plate 54 and 56, thereby accurately locating and helping to fixture both sidewall panels 70 and 72 relative to both end plates 54 and 56. Thereafter, each sidewall panel 70 and 72 is attached to each end plate 54 and 56, preferably by welding along the edge at each end of each panel 70 and 72. Such a locating and fixturing arrangement advantageously helps make assembly faster, easier, more accurate, and more economical. In addition, machine vibration is reduced during operation as the end plates 54 and 56 and sidewall panels 70 and 72 form a frame 52 of unitary construction that behaves as if it is formed of a single piece of material. Preferably, the machine frame 52 is constructed in accordance with that disclosed in U.S. Pat. No. 6,615,707, the disclosure of which is expressly incorporated herein by reference.

Components of the machine 40, including the end plates 54 and 56, the sidewall panels 70 and 72, the spacer bracket arrangement 252, and roller cradles 144 preferably are constructed to tight tolerances of at least 15 thousandths or better resulting better alignment of the rollers 42 and associated drive train components. This includes fastener holes formed in each such component. Each such component preferably is cut to such tight tolerances using a high energy density beam cutting process that preferably is a laser cutting process. As a result, roller vibration is reduced thereby advantageously enabling higher roller speeds and greater food product throughputs to be achieved.

Referring to FIG. 15, a food product processing machine 40 constructed in accordance with the invention is well suited for substantially simultaneously processing a plurality of pairs of pieces of food product 280. During operation, a plurality of pieces of food product 280 is introduced, preferably via the intake chute 92 at the inlet end 86 of the machine 40. Each roller 42 is rotated and engages pieces of food product 280 entering the food product processing chamber 134 processing the food product 280 as it travels along the food product processing chamber 134. Where equipped with an auger 98, the auger 98 is rotated to help urge each piece of food product 280 along the food product processing chamber 134 toward the discharge end 88. Liquid, such as water or the like, can be discharged from the orifices 78 of each conduit 76 to help keep the rollers 42 clean and to help facilitate removal of debris and other matter out the material removal opening 68 in the bottom of the machine 40. After processing is finished, the food product 280 is expelled out the discharge 91.

As each roller 42 rotates, each piece of food product 280 is processed in the food product processing chamber 134. For example, a food product processing machine 40 constructed in accordance with the invention can be used to peel, clean, dry, coat, powder, shape, or otherwise process food product 280. Where a coating or powder is applied, the coating or powder can be applied using one or more of the conduits 76. Other means can be used, if desired, to apply a coating or powder.

A food product processing machine 40 constructed in accordance with the invention is well suited for processing many different kinds and types of food product 280. For example, the machine 40 can be used to process potatoes, French fries, potato chips, carrots, beets, beans, onions, radishes, tomatoes, lettuce, apples, oranges, lemons, peaches, pears, and the like. Other types and kinds of food product, including food product that is not a vegetable or fruit, can also be processed with the machine 40.

In a preferred method of operation, the rollers 42 of the machine 40 are rotated at a speed of at least six hundred revolutions per minute and preferably at a speed of seven hundred fifty revolutions per minute or faster. In one preferred method, each one of the rollers 42 is rotated at a rotational speed of between nine hundred revolutions per minute and one-thousand two hundred revolutions per minute. As a result of rotating each roller 42 at these higher rotational speeds, each roller 42 remains cleaner longer, thereby allowing them to be used for a longer period of time without having to be manually cleaned or changed.

In addition, as a result of being able to stably rotate each one of the rolls 42 at these higher rotational speeds, a greater amount of food product 280 can be processed per hour. In one preferred method of operation, each roller 42 is rotated at a rotational speed of at least six hundred revolutions per minute enabling a food product processing machine 40 constructed in accordance with the invention to process at least 60,000 pounds of food product 280 per hour. In another preferred method of operation, each roller 42 is rotated at a rotational speed of at least nine hundred revolutions per minute enabling a food product processing machine 40 constructed in accordance with the invention to process at least 100,000 pounds of food product 280 per hour.

It is also to be understood that, although the foregoing description and drawings describe and illustrate in detail one or more preferred embodiments of the present invention, to those skilled in the art to which the present invention relates the present disclosure will suggest many modifications and constructions as well as widely differing embodiments and applications without thereby departing from the spirit and scope of the invention.

1. A food product peeling or cleaning machine comprising
a frame;
a plurality of rotatable rollers carried by the frame;
a drive; and
a coupling disposed intermediate the drive and each one of the plurality of rotatable rollers, wherein the coupling is configured to dampen vibration during operation.

2. The food product peeling or cleaning machine of claim 1, wherein each roller is rotated at a rate of greater than six hundred revolutions per minute.

3. The food product peeling or cleaning machine of claim 1, wherein each roller is rotated at a rate of greater than seven hundred and fifty revolutions per minute.

4. The food product peeling or cleaning machine of claim 1, wherein each coupling is elastomeric.

5. The food product peeling or cleaning machine of claim 1, further comprising a mounting bracket extending from the frame that carries the drive.

6. The food product peeling or cleaning machine of claim 5, wherein the frame has a pair of ends, the mounting bracket is spaced from one of the ends of the frame, and each coupling is disposed between the one of the ends of the frame and the mounting bracket.

7. The food product peeling or cleaning machine of claim 6, wherein each coupling comprises a flexible, elastomeric coupling.

8. The food product peeling or cleaning machine of claim 1, wherein the drive comprises a plurality motors that each drive a plurality of the rotatable rollers.

9. The food product peeling or cleaning machine of claim 8, further comprising a plurality of gear boxes, with each motor connected to a single one of the gear boxes, and each one of the gear boxes is connected to a plurality of the rollers.

10. The food product peeling or cleaning machine of claim 9, wherein there are between six and eleven rollers.

11. The food product peeling or cleaning machine of claim 9, wherein each one of the rollers comprises a brush.

12. The food product peeling or cleaning machine of claim 9, wherein each one of the gear boxes comprises a motor input and a plurality of output shafts with each one of the output shafts connected to one of the rollers by one of the couplings.

13. The food product peeling or cleaning machine of claim 9, wherein each one of the motors comprises an electric motor.

14. The food product peeling or cleaning machine of claim 1, further comprising a mounting bracket, wherein the frame has a pair of ends, the mounting bracket is spaced from one of the ends of the frame, each coupling is disposed between the one of the ends of the frame and the mounting bracket, the drive comprises a plurality of electric motors each carried by the mounting bracket, and each coupling is a flexible, elastomeric coupling.

15. The food product peeling or cleaning machine of claim 1, further comprising a mounting bracket and a gear box carried by the mounting bracket with the gear box connected to a plurality of the rotatable rollers, wherein the frame has a pair of ends, wherein the mounting bracket is spaced from one of the ends of the frame, wherein each coupling is disposed between the one of the ends of the frame and the mounting bracket, wherein the drive comprises a motor carried by the gear box, and wherein each coupling is a flexible, elastomeric coupling that connects one of the plurality of rotatable rollers to the gear box.

16. The food product peeling or cleaning machine of claim 15, wherein there are a plurality of gear boxes mounted to the mounting bracket with a single motor attached to each one of the gear boxes and each one of the gear boxes connected to a pair of rollers with each one of the pair of rollers being connected to its corresponding gear box by a single one of the flexible, elastomeric couplings.

17. The food product peeling or cleaning machine of claim 16, wherein each motor comprises an electric motor.

18. The food product peeling or cleaning machine of claim 16, wherein each one of the rollers comprises a brush.

19. The food product peeling or cleaning machine of claim 16, wherein each one of the rollers comprises an abrasive roller.

20. The food product peeling or cleaning machine of claim 16, wherein the plurality of rotatable rollers are arranged to have a U-shaped cross sectional configuration.

21. The food product peeling or cleaning machine of claim 16, wherein the frame is comprised of a sidewall that extends between a pair of end plates with one of the end plates being disposed at one of the ends of the frame and the other one of the end plates disposed at the other one of the ends of the frame.

22. The food product peeling or cleaning machine of claim 21, further comprising a cover that overlies the frame with each one of the rollers disposed between the cover and the sidewall of the frame.

23. The food product peeling or cleaning machine of claim 22, further comprising an auger disposed between the cover and the rollers.

24. A food product peeling or cleaning machine comprising:
a frame that includes a sidewall and a pair of end plates with one of the end plates disposed at one end and the other one of the end plates disposed at the other end;
a cover that overlies the sidewall of the frame;
a plurality of rotatable rollers disposed between the end plates;
a mounting plate spaced from one of the end plates;
a plurality of drives carried thereby; and
a plurality of flexible couplings disposed between the mounting plate and the rotatable rollers with each one of the flexible couplings connected to one of the plurality of rotatable rollers.

25. A food product peeling or cleaning machine comprising:
a frame that includes a sidewall and a pair of end walls;
a plurality of rotatable rollers rotatively supported at each end of the frame;
a mounting plate carried by the frame;
a drive box carried by the mounting plate, the drive box connected to a plurality of the rotatable rollers; and
a plurality of flexible couplings disposed between the drive box and one end of the rotatable rollers with each one of the flexible couplings connected to one of the plurality of rotatable rollers.

26. A food product peeling or cleaning machine comprising:
a frame that includes a sidewall and a pair of ends;
a plurality of roller support plates with one of the roller support plates located adjacent one end of the frame and the other one of the roller support plates located adjacent the other end of the frame, each roller support plate having a plurality of roller receiving notches;
a plurality of pairs of rotatable rollers each rotatively supported at each end by one of the roller support plates and each rotatable roller received in one of the notches of each one of the roller support plates;
a plurality of drive boxes that are connected to a plurality of the rotatable rollers with each rotatable roller connected thereto by a vibration dampening coupling; and
a plurality of electric motors with each one of the electric motors connected to a single one of the drive boxes.

27. A method of operating food product peeling or cleaning machine comprising:
(a) providing a frame that includes a sidewall and a pair of ends; a plurality of roller support plates with one of the roller support plates located adjacent one end of the frame and the other one of the roller support plates located adjacent the other end of the frame, each roller support plate having a plurality of roller receiving notches; a plurality of pairs of rotatable rollers each rotatively supported at each end by one of the roller support plates and each rotatable roller received in one of the notches of each one of the roller support plates; a plurality of drive boxes that are connected to a plurality of the rotatable rollers with each rotatable roller connected thereto by a vibration dampening coupling; and a plurality of electric motors with each one of the electric motors connected to a single one of the drive boxes; and
(b) rotating each one of the rollers at a speed greater than six hundred revolutions per minute;
(c) processing a plurality of pairs of pieces of food product substantially simultaneously by contact with one or more of the rollers.

28. A method of operating food product peeling or cleaning machine comprising:
(a) providing a frame that includes a sidewall and a pair of ends; a plurality of rotatable rollers each connected by a vibration dampening coupling to a drive box that is connected to a drive; and
(b) rotating each one of the rollers at a speed at least seven hundred and fifty revolutions per minute;
(c) processing a plurality of pairs of pieces of food product substantially simultaneously via contact with one or more of the rollers.
